(19) United States
(12) Patent Application Publication
(10) Pub. No.: US 2010/0213814 A1
(43) Pub. Date: Aug. 26, 2010

(54) RETAINING SLEEVE WITH RETENTION FEATURE

(75) Inventors: Mark D. Seymour, Hillsboro, NH (US); Joseph Wegman, Henniker, NH (US); Jason Lessard, Bow, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/389,898

(22) Filed: Feb. 20, 2009

(51) Int. Cl. H01J 5/50

(52) U.S. Cl. 313/318.01

(57) ABSTRACT

An automotive headlamp has a light source capsule including a seal area and a cup-shaped retainer affixed to the seal area. A plastic base includes a cavity arrayed about an axis and has a circumferential wall about the cavity. Axial slots are formed in the circumferential wall, the slots forming segments of a circle arching around the axis, the slots being further defined by a pair of oppositely disposed end stops. Metal inserts having base ends sized and shaped to closely fit the axial slots are positioned in the slots, each of the metal inserts having an extended resilient finger each having a retainer engager formed to engage the retainer. Retention features are formed with each of the base ends, the retention features engaging the circumferential wall and increasing the force necessary to remove the inserts.

### TECHNICAL FIELD

This invention relates to automobile headlights and more particularly to those headlights wherein a replaceable lamp unit is utilized.

### BACKGROUND ART

Automobile headlights wherein a replaceable lamp unit is employed as the light source are well known in the art. The instant invention is related to lamps of the variety described above. In particular, the invention defines a replaceable lamp unit, which assures that the electric lamp utilized therewith will be maintained in strict alignment as is necessary in automotive headlights.

The replaceable lamp defined herein assures that alignment of the electric lamp employed therewith will be maintained. That is, alignment of the glass envelope of the lamp relative to the unit's holder is provided such that the filament structure within the envelope (either a single coiled filament or two, spaced coiled filaments) will be accurately aligned relative to the optical axis of the reflector when the lamp unit is oriented within the reflector's rear opening. Such alignment is deemed critical to assure optimum headlight output in the direction(s) desired.

As also described herein, a preferred light source (which constitutes an important part of the replaceable lamp unit) is an electric lamp of the tungsten-halogen variety. One example of such a lamp is shown in U.S. Pat. No. 3,829,719, Westlund, Jr., et al., which is assigned to the assignee of the instant invention. In tungsten-halogen lamps, the tungsten, which constitutes the filament material, is evaporated from the filament during lamp operations and combines with the halogen to form a gaseous halide, the halide preventing the tungsten from depositing on the internal wall of the lamp envelope. Upon returning to the filament structure the halide decomposes, resulting in the deposition of tungsten back onto the filament structure and the release of the halogen gas to assure continuation on the cycle. The halogen cycle is well known in the art and lamps employing it have been used for some time. In the case of the two-beam (dual filament) lamp, a typical tungsten-halogen lamp provides about 65 watts when operated at high beam and about 55 watts at low beam. As stated, it is critical that the filament structure of the lamp within the automobile headlight be aligned relative to the reflector to provide optimum output of the finished headlight. Such alignment constitutes an important feature of the replaceable lamp unit defined herein.

### DISCLOSURE OF INVENTION

It is, therefore, an object of the invention to obviate the disadvantages of the prior art.

It is another object of the invention to enhance the alignment of automotive headlights.

Yet another object of the invention is the improvement of automotive headlights.

These objects are accomplished, in one aspect of the invention, by the provision of an automotive headlamp comprising a light source capsule including a seal area; a retainer affixed to the seal area, a plastic base including a cavity arrayed about an axis and a circumferential wall about the cavity; an annular receptor associated with the circumferential wall, a plurality of axial slots formed in the circumferential wall, the slots forming segments of a circle arching around the axis, the slots being further defined by angularly located end stops; a plurality of metal inserts having base ends sized and shaped to closely fit the axial slots positioned in the slots, each of the metal inserts having one or more extended resilient fingers provided with a retainer engager engaging and supporting the retainer, and a retention feature formed with each of the base ends, the retention feature engaging the annular receptor.

The use of the retainer and resilient fingers on the metal inserts allows for accurate positioning of the lamp relative to the plastic holder. Further, it removes any support function from the lamp lead-ins, allowing greater flexibility of the lead-in attachment to the necessary socket prongs.

### BRIEF DESCRIPTION OF THE DRAWINGS

FIG. 1 is an elevational view of an embodiment of the invention;

FIG. 2 is a sectional, plan view taken along the line 2-2 of FIG. 1;

FIG. 3 is an enlarged, perspective view of an insert according to an embodiment of the invention;

FIG. 4 is a sectional view taken along the line 4-4 of FIG. 2; and

FIG. 5 is a graph of force removal characteristics.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

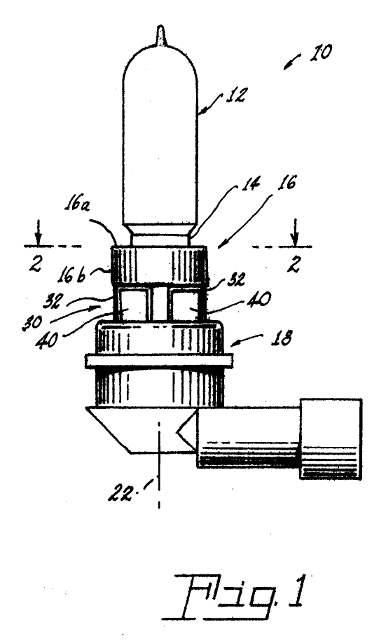

Referring now to the drawings with greater particularly, there is shown in FIG. 1 an automotive headlamp 10 having a light source capsule 12 that can be a tungsten-halogen and that includes a seal area 14 that contains lead-ins 14a and 14b. A retainer 16 comprising a metal up having a wall 16a and an opening 16b for receiving the real area 14 is affixed to the seal are by any suitable method.

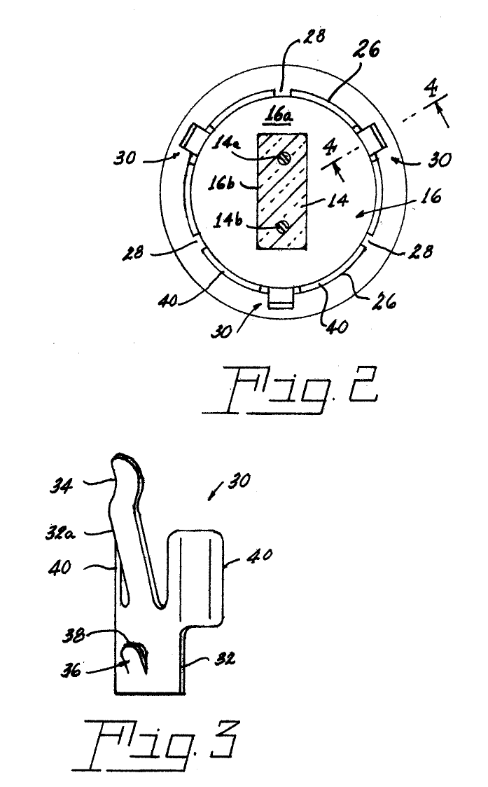

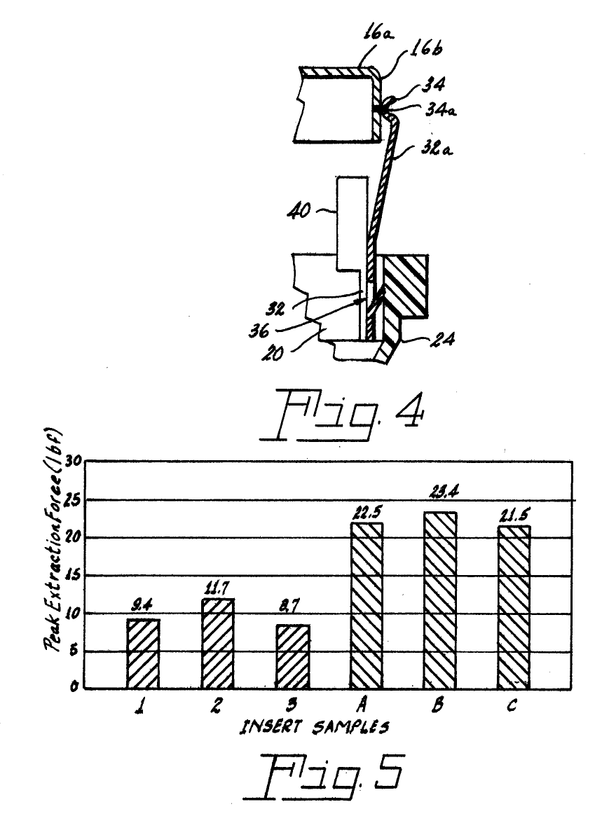

A plastic base 18 includes a cavity 20 arrayed about an axis 22 and has a circumferential wall 24 thereabout. Axial slots 26 are formed in the circumferential wall 24, these slots 26 forming segments of a circle arching around the axis 22. The slots 26 are further defined by angularly located end stops 28. The slots 26 and stops 28 are best seen in FIG. 2.

A plurality of metal inserts 30, preferably formed from a stamped metal such as 301 stainless steel, and having base ends 32 sized and shaped to closely fit the axial slots 26 are frictionally positioned in the slots 26, each of the metal inserts 30 having an extended resilient finger 32a provided with a retainer engager 34 for engaging and supporting the retainer 16. A retention feature 36, in the form of a prong 38, is struck from the base end 32, and engages the circumferential wall 24, drastically increasing the force necessary to remove the inserts, from an average of 9.9 lbf to 22.5 lbf (thereby increasing the strength of the entire unit) as shown in the graph depicted in FIG. 5. In the graph, Items 1, 2, and 3 represent inserts without retention features and Items A. B. and C represent inserts with the retention feature. In the preferred embodiment, at least one insert 30 is flexible, and preferably only slightly flexible so as to impart a relatively high spring constant. The insert are preferably formed with slightly differing circumferential curvatures so the insert must be circumferentially flexed to slide axially into the slot. The preferred insert 30, when in position in the slot, is then under tension or even high tension with respect to the internal walls forming the slot. This tension between the insert and slot helps accurately position and hold the insert with respect to the slot and therefore with respect to the base.

If desired, the inserts 30 can be provided with up-standing shields 40 arrayed on either side of the fingers 32a for the purpose, among others, of blocking light that may emerge from the capsule press area.

During the assembly of the light source capsule 12 to the base 18, the retainer 16 is positioned with the resilient fingers 32a and the lead-ins 14a and 14b connected to the necessary socket prongs (not shown). At this point the light source capsule 12 and its retainer can be moved about the axis 22 to achieve the proper filament alignment, at which time the retainer engagers 34 are welded to the retainer wall 16a, preferably by laser welding, although other forms of attachment can be employed.

Thus, there is provided a ruggedized, alignment-correct automotive headlamp that is economical to produce.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. An automotive headlamp comprising:
a light source capsule including a seal area;
a retainer affixed to said seal area;
a plastic base including a cavity arrayed about an axis and a circumferential wall about said cavity;
an annular receptor associated with said circumferential wall;
a plurality of axial slots formed in said circumferential wall, said slots forming segments of a circle arching around said axis, said slots being further defined by angularly located end stops;
a plurality of metal inserts having base ends sized and shaped to closely fit said axial slots positioned in said slots, each of said metal inserts having one or more extended resilient fingers provided with a retainer engager engaging and supporting said retainer; and
a retention feature formed with each of said base ends, said retention feature engaging said annular receptor.

2. The automotive headlamp of claim 1 wherein said retention feature comprises a prong struck from said base end.

3. The automotive headlamp of claim 1 wherein said inserts are formed from stamped metal.

4. The automotive headlamp of claim 1 wherein each of said inserts is formed with two extended fingers.

5. The automotive headlamp of claim 1 wherein said inserts are arrayed in a circle.
